(19) United States
(12) Patent Application Publication
(10) Pub. No.: US 2014/0268627 A1
(43) Pub. Date: Sep. 18, 2014

(54) Apparatus and Method for a Suspended Track and Curtain

(71) Applicant: Victor M. Contreras, JR., Berwyn, IL (US)

(72) Inventors: Victor M. Contreras, JR., Berwyn, IL (US); Jorge A. Contreras, Berwyn, IL (US)

(21) Appl. No.: 14/173,497

(22) Filed: Feb. 5, 2014

Related U.S. Application Data
(60) Provisional application No. 61/786,262, filed on Mar. 14, 2013.

(51) Int. Cl. F21V 21/005; F21V 33/00

(52) U.S. Cl. CPC F21V 21/005; F21V 33/0052
USPC 362/11; 362/3; 362/18; 362/16

(57) ABSTRACT

An apparatus comprises a track system. The track system comprises a first straight track portion, a first curved track portion, and a second straight track portion. The track portions are engaged with each other to form a continuous track. A plurality of simple connectors are engaged with the straight track portions, and a plurality of split connectors are engaged with the curved track portion. A plurality of threaded rods have a top end portion and a bottom end portion. The bottom end portions are engaged with at least some of the plurality of connectors. The top end portions are engaged with a frame structure. A roller is adapted to be moveable along the track system. A curtain is engaged with the roller for moving the curtain between an open position and a collapsed position along the track system in a generally looping motion.

### CROSS-REFERENCE TO RELATED APPLICATIONS

The present Utility patent application claims priority benefit of the U.S. provisional application for patent Ser. No. 61/786,262 entitled “The ZennAutoStudio”, filed on Mar. 14, 2013 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to photography. More particularly, the invention relates to a collapsible photo studio.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. A great deal of shopping currently occurs on the internet including, without limitation, shopping for automobiles. Typically, the automobile industry does not offer internet consumers high quality images of pre-owned and new automobiles. This may be for a variety of different reasons such as, but not limited to, not believing that high quality images make a difference with consumers, financial investment, lack of photography knowledge, logistics, etc. Furthermore, high quality images may be difficult to obtain when photographing automobiles outside due to various different factors including, without limitation, uncontrollable lighting and changing weather conditions, distractions such as, but not limited to, objects and or people in the background of photos, and evidence of the season, which may date the automobile being photographed. For example, without limitation, for auto dealerships located in areas of the country where there is snow, an automobile with snow in the background in the middle of summer can indicate to a potential buyer that the automobile has been on the lot for an extended amount of time, which may be a negative point against the dealership when negotiating price. In addition, one can expect that an internet consumer may have a short attention span or may be overwhelmed by the large number of choices that can result from a search. It is believed that virtually any model of vehicle in virtually every color can be found on the internet with the only difference sometimes being price and image representation.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1C illustrate an exemplary collapsible automobile photo studio, in accordance with an embodiment of the present invention. FIG. 1A is a side perspective view of the photo studio in an open position. FIG. 1B is a side perspective view of the photo studio in a collapsed position, and FIG. 1C is a front perspective view of the photo studio in the collapsed position

FIG. 2 is a bottom perspective view of a portion of an exemplary track system for a collapsible photo studio, in accordance with an embodiment of the present invention;

FIG. 3 is a side perspective view of an exemplary simple connector, in accordance with an embodiment of the present invention;

FIG. 4 is a diagrammatic side view of an exemplary split connector, in accordance with an embodiment of the present invention;

FIG. 5 is an front view of an exemplary roller inside a piece of track for a collapsible photo studio, in accordance with an embodiment of the present invention; and

FIGS. 6A and 6B illustrate an exemplary collapsible photo studio in use, in accordance with an embodiment of the present invention. FIG. 6A is a front perspective view of the studio set up to take a photo of the front passenger side of an automobile, and FIG. 6B is a rear view of the studio set up to take a photo of the rear driver's side of the automobile.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention involves a permanent automobile photo studio for car dealers that may be installed inside a car dealer's building to photograph and or video their inventory in a controlled lighting environment for the marketing of their auto inventory on the internet and or print media, etc. Some embodiments may comprise features such as, but not limited to, a suspended curtain in an endless loop in which an automobile may be parked. This curtain can be moved to provide a consistent background as the automobile is photographed from every angle for the purpose of marketing said automobile for sale online. Some embodiments may be purchased by an auto dealership or other type of end client to be installed in a building to be used to photograph and market inventory on the internet or anywhere else where a professional image of their automobiles may be used, for example, without limitation, in print ads or brochures.

FIGS. 1A through 1C illustrate an exemplary collapsible automobile photo studio, in accordance with an embodiment of the present invention. FIG. 1A is a side perspective view of the photo studio in an open position. FIG. 1B is a side perspective view of the photo studio in a collapsed position, and FIG. 1C is a front perspective view of the photo studio in the collapsed position. In the present embodiment, the photo studio may be permanently installed in an auto dealer's building, out building or temporary building such as, but not limited to, a tent or pre-fabricated building to photograph and or video the auto dealership's inventory in a controlled lighting environment. These photos may be used for various different purposes such as, but not limited to, marketing auto inventory on the internet or in print media, keeping track of inventory, etc. Referring to FIG. 1A, the photo studio comprises a track system 100 that is attached to a building's ceiling 105. A curtain 110 is attached to track system 100 so that curtain 100 may slide back and forth on track system 100. This may be accomplished using various different means including, without limitation, rollers, as illustrated by way of example in FIG. 5, bearings, sliding rings, etc. Track system 100 may be made of various different materials such as, but not limited to, galvanized steel, aluminum, other metals, plastic, etc. In the present embodiment, track system 100 measures 18 feet in width by 25 feet in length to accommodate larger SUV's and four door full size pick-up trucks. Track system 100 forms a rectangular shape with 90 degree curves at each corner to generally enable curtain 110 to freely travel the entire length of track system 100 in an endless loop, which may provide the subject matter, for example, without limitation, a motor vehicle, with a constant and even background at every angle that is generally free from distractions that may be caused by humans or other objects. Those skilled in the art will readily recognize, in light of and in accordance with the teachings of the present invention, that track systems in some alternate embodiments may be configured in various different shapes or sizes. For example, without limitation, some track systems may be implemented in a “U” shape, an “L” shape, circular or oval shapes, etc. Some embodiments may be made larger or smaller depending on the type of items being photographed. For example, without limitation, smaller embodiments may be used to accommodate smaller vehicles such as, but not limited to, motorcycles, ATV's, snowmobiles, golf carts, etc., and larger embodiments may be used to photograph larger vehicles such as, but not limited to, tractor-trailers, commercial trucks, farm equipment, construction vehicles, etc.

In the present embodiment, curtain 110 is made of a reflective rip-stop nylon material and measures 10 feet in height by 60 feet in length. Curtain 110 may be made from 5 foot wide pieces of rip-stop vinyl from a roll that are held together with double sided tape as well as sewing. The reflective properties of curtain 110 may allow for light to bounce off curtain 110 and bathe the object being photographed in light from front to back and top to bottom. Curtains in some alternate embodiments may be made in various different colors or fabrics such as, but not limited to, canvas, other cloths, plastic, etc. If the curtain is made of a cloth or plastic without reflective properties, there may be less light on the sides and lower portions of the object than with a reflective fabric, which may or may not be compensated for with a flash or with camera settings. Furthermore, some alternate embodiments may be made using various different methods such as, but not limited to, attaching material pieces of different sizes together using a multiplicity of suitable attachment means including, without limitation, adhesives or sewing, or by making the curtain from a single piece of material. In the present embodiment, curtain 110 comprises end panels 115 that measure approximately 5 feet from each end of curtain 110. Referring to FIG. 1B, end panels 115 may be connected at multiple points along the edges of end panels 115, for example, without limitation, 1 foot from the bottom, 3 feet from the bottom, and 6 feet from the bottom, to hold curtain 110 in the collapsed position and to act as a storage bag. It is contemplated that end panels 115 may be held together using various different means including, without limitation, hook and loop material, snaps, buttons, buckles, ties, etc. This feature may provide protection to curtain 110 as well as a pleasing look to the hanging curtain 110 when the photo studio is not in use. Referring to FIG. 1C, when curtain 110 is held in the collapsed position, the area under track system 100 may be used as needed by the dealership, for example, without limitation, for parking, for storage, as a showroom, etc. Some embodiments may be implemented without end panels of a different material, and may be held in the collapsed position by attachment means on the curtain itself.

Referring to FIGS. 1A and 1C, in the present embodiment lighting comes from a minimum of four light cabinets 120 with reflective directional panels strategically positioned over the edges of track system 100 and facing a diffuser 125 at an angle of 45 degrees. Each light cabinet 120 comprises six high-power fluorescent light bulbs with chrome reflectors to direct the light beam downward and measures 4 feet in length by 2 feet in width by 1 foot in depth. Each light cabinet 120 comprises a rectangular frame made from PVC plastic pipe measuring ½″ covered with a black non-translucent cloth material. The frames are then attached to the light fixtures to create light cabinets 120. In the present embodiment, light cabinets 120 may be installed in strategic locations around track system 100 to help maximize the reflective properties of the photo studio in order to bathe the entire vehicle with even light. The position of light cabinets 120 along the longer sides of the studio is at the center point of the longer sides, and the position of light cabinets 120 along the shorter sides is to the right or left of the center of the shorter sides depending on the first photograph taken of the subject matter. For example, without limitation, if the first photograph of the subject matter is a front view of the passenger side with the automobile facing the front of the studio, light cabinet 120 at the front of the studio is placed on the left side of the center of the studio to illuminate the passenger side of the automobile, which is also on the left side of the studio. The light cabinet 120 at the rear of the studio is typically placed on the opposite side of light cabinet 120 in the front of the studio, the right side of the studio in this non-limiting example. Those skilled in the art will readily recognize, in light of and in accordance with the teachings of the present invention, that some embodiments may be implemented with more or fewer light cabinets in various different configurations. Furthermore, the light cabinets in some embodiments may be larger or smaller or may be designed differently. For example, without limitation, some light cabinets may be implemented without reflectors or may use different types of lighting including, without limitation, incandescent bulbs, LEDs, neon tubes, etc. Also, the cabinets may be made in various different shapes such as, but not limited to round shapes, bar lights, single light fixtures rather than cabinets, etc. Furthermore, the frames of the light cabinet may be made of a multiplicity of suitable materials including, without limitation, an aluminum frame, plastic sheets, wood, etc.

In the present embodiment, diffuser 125 covers the entire area within track system 100 and may be made of a rip-stop vinyl material similar to the material used for curtain 110 yet thinner to typically enable more light to pass through diffuser 125. Diffuser 125 is most often white so that the color of the vehicle being photographed is accurate in the photograph, yet in some applications diffusers of various different colors may be used. Diffuser 125 may be put together using the same processes that may be used to make curtain 110. Diffuser 125 typically transforms defined beams of light from light cabinets 120 into soft light that creates a blanket of light that covers the entire vehicle being photographed and typically creates hot spots at designated locations to accentuate the body lines of the vehicle being photographed. The angle and placement of light cabinets 120 in conjunction with the diffuser 125 allows for the creation of positive reflection on the vehicle. Positive reflection is an effect created by the diffused light coming from the light cabinets 120, whereby “hot spots” (areas of intense soft light) are created at specified areas of the subject being photographed. The hot spots created by light cabinets 120 reflect on the lines of the body of the vehicle, which will enable a viewer of a photo taken in this environment to see all of the angles and curves of the body of the vehicle. It is believed that these angles and curves are usually lost when photographing a vehicle outside due to over exposure in which the lines and curves of the vehicle are lost in excess light or under exposure in which shadows cover the lines and curves of the vehicle, eliminating key components of the design of the vehicle. It is believed that these key design elements contribute to the emotional attachment the viewer will or should have when considering the subject (vehicle) for purchase after viewing a photograph taken in this environment. It is contemplated that some embodiments may be implemented without a diffuser. However, this may cause the vehicle being photographed to show negative reflection, including, without limitation, reflection of the light cabinets, any other lights in use that are in range of the photograph, the actual building ceiling structure, etc. Some embodiments may be implemented without light cabinets and may rely on the existing building light source. These embodiments may or may not comprise a diffuser. Yet lower quality photos may be produced by these embodiments. Also, the user would likely need to position the studio directly in the path of the existing light fixtures of the building.

FIG. 2 is a bottom perspective view of a portion of an exemplary track system for a collapsible photo studio, in accordance with an embodiment of the present invention. In the present embodiment, the track system comprises 4 curves 200, 10 pieces of straight track 205, 6 simple connectors 210 that attach the pieces of straight track 205, and 8 split connectors 215 that hold curves 200 in place. In order for the unobstructed and smooth travel of the curtain 110 throughout the track system 100 in an endless loop, the track system 100 should be level. This can be accomplished by following the original design. Simple connectors 210 are designed to not only hang the pieces of straight track 205 to the ceiling of the building but also to keep them straight and leveled by allowing a small portion of each piece of straight track 205 to be inserted in the simple connector 210, thereby creating a rigid structure. The split connectors 215, on the other hand, do not have an area for the pieces of straight track 205 to be inserted in them; therefore they cannot create a rigid and leveled path for the curtain 110 to travel through. They are located in front of the curves 200 and it is better to have two at every corner of the track system 100 to provide an even hold and maintain a level track system 100 for the curtain 110 to travel in. The track system 100 may be installed in a building by attaching threaded rods 220 to simple connectors 210 and split connectors 215, illustrated by way of example in FIG. 3 and FIG. 4, respectively. Threaded rods 220 are then connected to a uni-strut or super-strut system 225 which is connected to the ceiling of the building. Uni-strut or super-strut is commonly used in electrical installations. It is contemplated that a multiplicity of suitable means may be used to connect the track system to the ceiling of a building such as, but not limited to, wires rather than threaded rods, different types of connectors, means that connect the track directly to the ceiling, etc. In the present embodiment, rollers, as illustrated by way of example in FIG. 5, that hold the curtain may be located within and travel through the track system. The curtain is typically able to travel unobstructed on rollers inside the track system in an endless loop, largely providing flexibility as to curtain position in relation to the static subject matter, for example, without limitation, an automobile. Once the track system is installed, a user may stage the subject matter in the middle of the studio and have access to photograph every angle of the subject by simply moving the curtain in the track system to position the curtain behind each photograph taken. In the present embodiment, the entire system is built using commercial quality materials to generally ensure a long service life. Some embodiments may be made using materials of lesser quality to compete at a lower price or for smaller-scale applications.

FIG. 3 is a side perspective view of an exemplary simple connector 210, in accordance with an embodiment of the present invention. In the present embodiment, simple connector 210 comprises a sleeve 300 and an extended tab 305, which extends upward from connector 210. The ends of two straight pieces of track are slid into sleeve 300 and set screws may be screwed into holes 310 to hold the pieces of track in place. In some alternate embodiments the tracks may be welded to the connectors or held in place using various different means such as, but not limited to, bolts or rubber gaskets. In the present embodiment, the threaded rods that attach connector 210 to a uni-strut or super-strut connects to connector 210 at a hole 320 in extended tab 305.

FIG. 4 is a diagrammatic side view of an exemplary split connector 215, in accordance with an embodiment of the present invention. In the present embodiment, split connector 215 comprises an L shaped member 400 with an attached extended tab 405 with a hole 410 where a threaded rod may be connected. A removable member 415 is attached to L shaped member 400 with a nut and bolt or a screw 420. The removable member 415 is part of the split connector 215. It is a metal tab that is used to clamp the side of the track using a screw in the split connector 215 and a nut to attach to the split connector 215 and is used to firmly attach the split connector 215 to the piece of straight track 205 while allowing for a leveled and smooth travel of the curtain 110. FIG. 5 is a front view of an exemplary roller 500 inside a piece of track 505 for a collapsible photo studio, in accordance with an embodiment of the present invention. In the present embodiment, roller 500 comprises two wheels 510 and a hook 515. Wheels 510 roll in grooves 520 in track 505, and hook 515 may be attached to a curtain. It is contemplated that a multiplicity of suitable rolling or sliding means may be used to enable the curtain to travel around the track system such as, but not limited to, rollers with single wheels, bearings, sliding blocks, etc.

FIGS. 6A and 6B illustrate an exemplary collapsible photo studio in use, in accordance with an embodiment of the present invention. FIG. 6A is a front perspective view of the studio set up to take a photo of the front passenger side of an automobile 600, and FIG. 6B is a rear view of the studio set up to take a photo of the rear driver's side of automobile 600. In the present embodiment, the photo studio typically acts as a prop to improve the appearance of photos taken of an auto dealership's inventory of motor vehicles. The studio can function in almost any dealership environment with enough floor area and ceilings of a sufficient height to accommodate a curtain 605 and light cabinets 610. A track system 615 and light cabinets 610 hang from the ceiling generally leaving the area used unobstructed when the studio is not in use. Therefore, the studio can be installed in a multiplicity of suitable locations including, without limitation, inside a showroom, inside a service department, in a corner or the middle of a service drive, in a warehouse etc. In some applications, a user may choose to install or build a temporary building such as, but not limited to, a tent or a pre-fabricated structure and then install the photo studio in this building. Although a larger financial investment may be required, an auto dealership with limited or no indoor space may choose this type of embodiment.

In typical use of the present embodiment, a user can move curtain 605 to be positioned behind an appropriate area of automobile 600 for the desired photograph and then take a picture of automobile 600. The user may move curtain 605 to various different locations behind automobile 600 in order to take photographs of automobile 600 from multiple angles without the need to move automobile 600. It is contemplated that the entire outside of automobile 600 can be photographed with the same background easily by moving curtain 605 using one hand to pull curtain 605 along while walking and following track system 615. Track system 615 forms an endless loop to provide freedom of motion of curtain 605 and may enable curtain 605 to be easily repositioned in case of specialty angle shots of automobile 600. Curtain 605 comprises end panels 615 of a contrasting color for storage. Another benefit of end panels 615 being darker in color than curtain 605 is to help maintain the cleanliness of curtain 605, as panels 615 give users a place to hold curtain 605 to generally prevent curtain 605 from getting dirty from dirty hands and protect curtain 605 from dirt while in a stowed position.

An exemplary method of capturing a sequence of photographs that has proven results, with real internet consumers positively commenting on the quality, quantity and selection of photographs, while typically minimizing the time needed to capture these photographs in accordance with an embodiment of the present invention is as follows. This method typically enables a user to photograph every angle of automobile 600 without the need to move automobile 600. First the user starts with curtain 605 in position 1, as shown by way of example in FIG. 6A. Then the user moves around automobile 600 photographing various different angles of the outside of automobile 600 starting at the front of automobile 600 while moving curtain 605 around with him to generally maintain a constant background in the photographs. The user ends with curtain 605 in position 2, as shown by way of example in FIG. 6B to photograph the rear of automobile 600. Then, the user may photograph the interior of automobile 600 with the same even looking background. Upon completing the photographs and without moving the curtain from position 2, automobile 600 is removed from the studio and a new car is moved in its place. Now curtain 605 may be moved back to position 1 to restart the process. Using this method, the user may be able to capture 30 to 40 high quality photographs of the exterior and interior of automobile 600 in about 7 minutes or 15 to 20 images in about 4 minutes. It is contemplated that users may position the curtain and take photographs in any sequence desired. The foregoing method is meant to illustrate a method that enables the user to quickly photograph an entire vehicle.

Many auto dealerships have grown their inventories to incredible numbers, meaning that many vehicles may need to be marketed and photographed every day. Some embodiments of the present invention may be used to provide means for photographing automobiles more quickly than with most conventional methods. Furthermore, some embodiments may help to mitigate problems that may be experienced by photographing automobiles in open air parking lots, specifically the inability to control the light and to maintain a consistent background. The use of a corner inside a building as a consistent background was contemplated, yet this proved difficult because of the logistics of a car dealership where every corner of space is in use. In addition, the automobile must be moved in order to photograph both sides while keeping the same background. Other potential solutions include, without limitation drilling holes in a parking lot to temporarily install PVC pipes ten feet in length by two inches in width to form a rectangular frame to which a tarp material may be attached to create a solid background and hanging fixed cloth panels from a ceiling of a building warehouse to form a box into which a vehicle may be placed. These designs proved to be cumbersome and inefficient. Replacing the track system with hanging rods holding draped cloth typically reduces the ability to move fast, as 4 different curtains must be moved into position for each shot.

An embodiment of the present invention provides a controlled lighting environment in which to photograph and or capture video of automobile inventory. This embodiment typically enables a curtain that travels the entire length of a track system in an endless loop to provide a consistent background while typically allowing for the automobile to remain unmoved while a photographer shoots every angle. This and some other embodiments provide benefits and advantages over conventional methods including, without limitation, the ability to photograph automobiles quickly, the ability to photograph multiple automobiles in an “assembly line” type process, quality photographs that resemble the factory's advertisement, a solid background without distractions that typically enables viewers to focus on the subject at hand, consistent and even lighting with no worries for changing weather conditions, uniformity in photographs that may enable a customer to more easily browse through inventory, etc. Furthermore, this embodiment may enable a dealership to use an area of a building that was previously underutilized such as, but not limited to, a storage area or a service department and transform this area into a marketing advantage.

An alternate embodiment uses an “L” shaped studio with one long side, a curve and a shorter side with a curtain hanging on a track system with rollers. The curtain in this embodiment may not be available as a background for every shot, and the vehicle may need to be turned around to be able to capture both sides with the same background. This embodiment has the potential to provide quality photographs yet may not be time efficient. “L” shaped embodiments may be useful in applications in which space, ceiling area, or budget is limited.

Another alternate embodiment comprises a track that forms a “U” shaped studio. This embodiment typically required less curtain movement than “L” shaped embodiments yet still may require the automobile to be moved in order to capture all angles.

Yet another alternative embodiment may provide a completely mobile studio which, instead of being suspended from a ceiling, is mounted on a minimal frame on wheels that typically enables the entire structure to be mobile instead of being fixed in one position. In some embodiments, the mobile frame may be optionally collapsible. If desired, this mobile studio may be taken to automobiles sitting in a lot or in a storage building, which may save more time and effort. All of the lighting, power sources, studio equipment, etc., can be installed onto the mobile frame so that the studio can be mobile for a whole day of shooting. In some embodiments the frame may be sized so that the left and right side walls can fit in between parked cars in a dealer parking lot as the frame is rolled over a parked car. Some embodiments may also comprise a roof to better control lighting conditions and to be more weather proof.

Yet other embodiments may comprise a multiplicity of suitable features in addition to or instead of the features described in the foregoing including, without limitation, curtains with patterns or pictures, a curtain that allows for the use of green screen technology, multiple curtains on one track, multiple curtains on multiple tracks, etc. One alternate embodiment may comprise a battery operated or electric motor to pull the curtain via a remote control or a hardwired switch. Another alternate embodiment may comprise lighting fixtures that are on separate switches to enable a user to control the amount of light and the direction from which the light is coming.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a collapsible photo studio according to the present invention will be apparent to those skilled in the art. Various aspects of the invention have been described above by way of illustration, and the specific embodiments disclosed are not intended to limit the invention to the particular forms disclosed. The particular implementation of the collapsible photo studio may vary depending upon the particular context or application. By way of example, and not limitation, the collapsible photo studios described in the foregoing were principally directed to implementations for photographing motor vehicles; however, similar techniques may instead be applied to photographing a multiplicity of suitable objects such as, but not limited to, furniture, trailers, rvs, machinery, farm equipment, sculptures, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a track system, wherein said track system comprises:
a first straight track portion having a first end portion and a second end portion;
a first curved track portion having a first end portion and a second end portion, said first end portion of said first curved track portion being engaged with said second end portion of said first straight track portion; and
a second straight track portion having a first end portion and a second end portion, said first end portion of said second straight track being engaged with said second end portion of said first curved track portion;
a plurality of simple connectors engaged with said straight track portions;
a plurality of split connectors engaged with said curved track portions;
a plurality of threaded rods having a top end portion and a bottom end portion, said bottom end portions of said threaded rods being engaged with at least some of said plurality of simple connectors and at least some of said plurality of split connectors, and said top end portions of said threaded rods being engaged with a frame structure;
a roller adapted to be moveable along said track system; and
a curtain engaged with the roller for moving said curtain between an open position and a collapsed position along said track system in a generally looping motion.

2. The apparatus of claim 1, wherein said track system further comprises:
a second curved track portion with a first end portion and a second end portion, said first end portion of said second curved track portion being engaged with said second end portion of said second straight track portion; and
a third straight track portion with a first end portion and a second end portion, said first end portion of said third straight track portion being engaged with said second end portion of said second curved track portion.

3. The apparatus of claim 2, wherein said track system further comprises:
a third curved track portion with a first end portion and a second end portion, said first end portion of said third curved track portion being engaged with said second end portion of said third straight track portion;
a fourth straight track portion with a first end portion and a second end portion, said first end portion of said fourth straight track portion being engaged with said second end portion of said third curved track portion; and
a fourth curved track portion with a first end portion and a second end portion, said first end portion of said fourth curved track portion being engaged with said second end portion of said fourth straight track portion and said second end portion of said fourth curved track portion being engaged with said first end portion of said first straight track portion, thereby creating an endless loop track system.

4. The apparatus of claim 1, wherein said track system is made of galvanized steel.

5. The apparatus of claim 1, wherein said track system comprises grooves for wheels.

6. The apparatus of claim 1, wherein said curtain is made of a reflective material which allows for light to bounce off of said curtain, thereby casting additional light on a subject.

7. The apparatus of claim 1, wherein said curtain further comprises end panels.

8. The apparatus of claim 1, wherein the frame structure is a uni-strut or super-strut system engaged with a ceiling of a building.

9. The apparatus of claim 1, wherein the frame structure is a mobile frame, thereby allowing the apparatus to be moved to a subject.

10. The apparatus of claim 1, wherein the roller comprises two wheels and a hook, thereby allowing said curtain to engage with the roller by hanging from the hook.

11. The apparatus of claim 1, wherein the roller comprises a sliding ring or block.

12. The apparatus of claim 1, further comprising at least one diffuser for softening a beam of light being cast on a subject.

13. The apparatus of claim 12, wherein the at least one diffuser is made of a white material.

14. The apparatus of claim 1, further comprising at least one lighting cabinet for casting a beam of light on a subject.

15. The apparatus of claim 14, wherein the at least one lighting cabinet comprises:
a fluorescent light bulb;
a chrome reflector for directing the beam of light; and
a rectangular frame for housing the fluorescent light bulb and the chrome reflector.

16. The apparatus of claim 14, further comprising:
at least one diffuser for softening the beam of light being cast on the subject,
wherein the at least one lighting cabinet and the at least one diffuser are configured to enable the creation of a positive reflection of light on the subject at a designated location, thereby highlighting a design component of the subject.

17. A method comprising:
placing a first lighting cabinet at a generally central point of a first long side of a photo studio;
placing a second lighting cabinet at a generally central point of a second long side of the photo studio;
placing a third lighting cabinet within a general proximity to a point of interest of a subject along a first short side of the photo studio, wherein the first short side of the photo studio is generally located closer to the point of interest of the subject than a second short side of the photo studio, thereby providing better illumination of the point of interest of the subject;
placing a fourth lighting cabinet away from a general proximity to the point of interest of the subject along the second short side of the photo studio, wherein the second short side of the photo studio is generally located farther from the point of interest of the subject than the first short side of the photo studio; and
placing a diffuser between at least one of the lighting cabinets and the subject to thereby enable the creation of a positive reflection of light on the subject at the point of interest.

18. The method of claim 17, further comprising raising the lighting cabinets to a point above a suspended track and curtain of the photo studio.

19. An apparatus comprising:
a suspension means for suspending a track system in a first position relative to a subject;
a track system means for guiding a curtain means to a second position relative to the subject; and
a roller means adapted to be moveable along said track system means,
wherein said curtain means is engaged with said roller means and is configured to move between an open position and a collapsed position along said track system means in a generally looping motion.

20. The apparatus of claim 19, further comprising illuminating means and diffusing means for creating a positive reflection of light on a subject at a designated location, thereby highlighting a design component of the subject.
